(19) United States
(12) Patent Application Publication
(10) Pub. No.: US 2026/0027625 A1
(43) Pub. Date: Jan. 29, 2026

(54) COATED TOOL AND CUTTING TOOL

(71) Applicant: KYOCERA CORPORATION, Kyoto-shi, Kyoto (JP)

(72) Inventors: Takumi HASHIMOTO, Satsumasendai-shi, Kagoshima (JP); Yuusuke NURUKI, Satsumasendai-shi, Kagoshima (JP)

(21) Appl. No.: 18/994,608

(22) PCT Filed: Jul. 4, 2023
(86) PCT No.: PCT/JP2023/024715

§ 371 Date: Jan. 15, 2025

(30) Foreign Application Priority Data
Jul. 21, 2022 (JP) 2022-116251

(51) Int. Cl. B23B 27/14

(52) U.S. Cl. CPC B23B 27/148; B23B 2228/105

(57) ABSTRACT

A coated tool in a non-limiting embodiment of the present disclosure includes a base and a coating layer located on a surface of the base. The base includes a coating adhesion phase containing at least one kind of metal compound selected from carbide, nitride, and carbonitride, each of which contains Ti and W, and Co. The coating adhesion phase is located at an interface between the base and the coating layer. A cutting tool in a non-limiting embodiment of the present disclosure includes a holder that extends from a first end toward a second end and includes a pocket on a side of the first end, and the coated tool located in the pocket.

### CROSS-REFERENCE TO RELATED APPLICATION

The present application claims priority to Japanese Patent Application No. 2022-116251, filed Jul. 21, 2022. The contents of this application are incorporated herein by reference in their entirety.

### TECHNICAL FIELD

The present disclosure relates to a coated tool and a cutting tool.

### BACKGROUND

Cemented carbide including WC (tungsten carbide) as a hard phase is used for a base, etc. in a coated tool, and is applied to a cutting tool, such as an end mill. For example, Japanese Unexamined Patent Publication No. 2004-100004 (Patent Document 1) describes a coated cemented carbide with a layered coating adhesion phase formed between a coating and a base material of cemented carbide. The layered coating adhesion phase is composed of at least one kind of metal compound selected from carbide, nitride, carbonitride, each of which contains Ti and W.

Japanese Unexamined Patent Publication No. 1-252306 (Patent Document 2) describes a cutting tool in which a coating layer is formed on a surface of a base of cemented carbide by interposing an adhesion enhancement layer therebetween. The adhesion enhancement layer is comprised of a lower layer including Co and W at predetermined individual proportions and the rest that is titanium carbide, an intermediate layer composed of titanium carbonitride, etc., and an upper layer composed of titanium carbide.

### SUMMARY

A coated tool in a non-limiting embodiment of the present disclosure includes a base and a coating layer located on a surface of the base. The base includes a coating adhesion phase containing at least one kind of metal compound selected from carbide, nitride, and carbonitride, each of which contains Ti and W, and Co.

The coating adhesion phase is located at an interface between the base and the coating layer.

A cutting tool in a non-limiting embodiment of the present disclosure includes a holder that extends from a first end toward a second end and includes a pocket on a side of the first end, and the coated tool located in the pocket.

### BRIEF DESCRIPTION OF THE DRAWINGS

FIG. 1 is a perspective view illustrating a coated tool in a non-limiting embodiment of the present disclosure;

FIG. 2 is a schematic diagram of a cross section in the vicinity of an interface between a base and a coating layer in the coated tool illustrated in FIG. 1;

FIG. 3 is a sectional view illustrating a neighborhood of a surface of a coated tool in a non-limiting embodiment of the present disclosure;

FIG. 4 is a sectional view illustrating a neighborhood of a surface of a coated tool in a non-limiting embodiment of the present disclosure; and

FIG. 5 is a perspective view illustrating a cutting tool in a non-limiting embodiment of the present disclosure.

### EMBODIMENT

### <Coated Tool>

A coated tool 1 in a non-limiting embodiment of the present disclosure is described in detail below with reference to the drawings. For the convenience of description, the drawings referred to below illustrate, in simplified form, only main members necessary for describing embodiments. Hence, the coated tool 1 may include any arbitrary structural member not illustrated in the drawings referred to. Dimensions of the members in the drawings faithfully represent neither dimensions of actual structural members nor dimensional ratios of these members. These points are also true for a cutting tool described later.

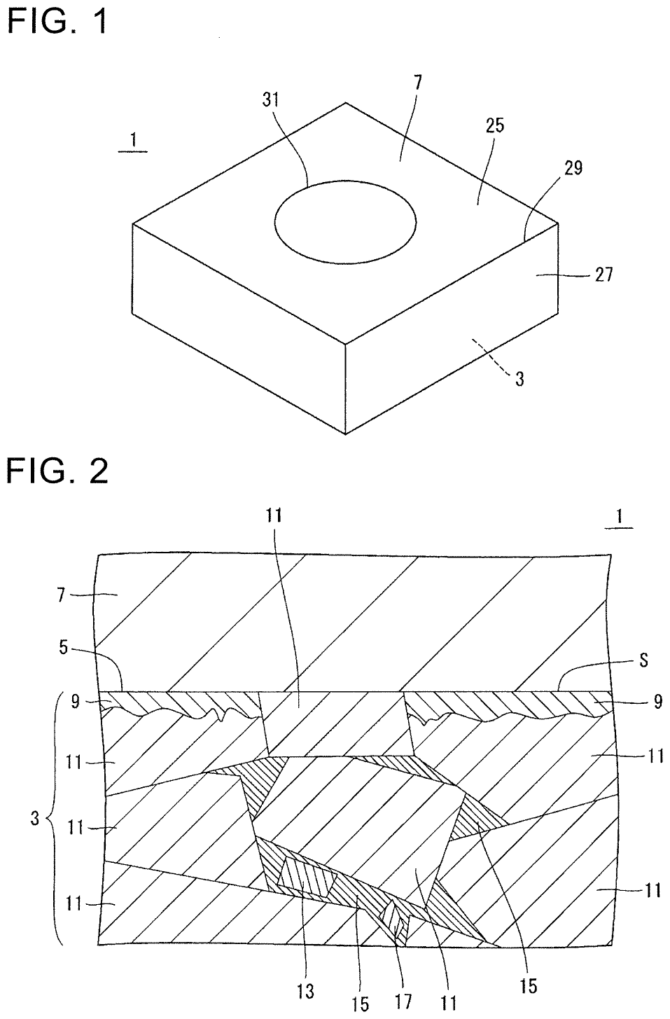

The coated tool 1 may include a base 3 and a coating layer 7 (film layer) located on a surface 5 of the base 3 as in a non-limiting embodiment illustrated in FIGS. 1 and 2.

The base 3 may include a coating adhesion phase 9. The coating adhesion phase 9 may be a part of the base 3. The coating adhesion phase 9 may include at least one kind of metal compound selected from carbide, nitride, and carbonitride, each of which contains Ti (titanium) and W (tungsten), and Co (cobalt).

The coating adhesion phase 9 may contain the metal compound and Co as a main component. The term “main component” as used herein may mean a component having the largest value of percent by mass compared to other components. Accordingly, a total value of percent by mass of the metal compound and Co may be largest in the coating adhesion phase 9. Components having top two values of percent by mass among the components contained in the coating adhesion phase 9 may be the metal compound and Co.

An elemental analysis may be carried out by, for example, Energy-Dispersive X-ray Spectroscopy (EDS). The elemental analysis may be carried out by a cross-section observation using an EDS included in an electron microscope. Examples of the electron microscope may include Scanning Electron Microscope (SEM) and Transmission Electron Microscope (TEM).

The coating adhesion phase 9 may be located at an interface S between the base 3 and the coating layer 7 as in the non-limiting embodiment illustrated in FIG. 2. The coating adhesion phase 9 having the above composition is servable as a phase that enhances adhesion to the coating layer 7 in the base 3. Therefore, if the coating adhesion phase 9 is located at the interface S between the base 3 and the coating layer 7, it is easy to improve adhesion between the base 3 and the coating layer 7. Hence, the coated tool 1 has enhanced adhesion between the base 3 and the coating layer 7. The coated tool 1 also has high wear resistance.

The base 3 may include a hard phase 11, a solid solution phase 13, and a binding phase 15.

The hard phase 11 may contain W and C. In other words, the hard phase 11 may contain WC. The hard phase 11 may contain WC as a main component. Components having top two values of percent by mass among the components contained in the hard phase 11 may be W and C.

The solid solution phase 13 may contain W, C, and Ti. The solid solution phase 13 may contain W, C, and Ti as a main component. That is, a total value of percent by mass each of W, C, and Ti may be largest in the solid solution phase 13. Components having top three values of percent by mass among the components contained in the solid solution phase 13 may be W, C, and Ti.

The binding phase 15 may contain an iron group metal. Examples of the iron group metal may include Co and Ni (nickel). The binding phase 15 may contain at least one of Co and Ni. The binding phase 15 may contain the iron group metal as a main component. The binding phase 15 is servable as a phase that bonds the hard phases 11 adjacent to each other.

The base 3 may be cemented carbide comprised of the hard phase 11, the solid solution phase 13, and the binding phase 15. The coating adhesion phase 9 may have a larger content of each of a β component and Co than the binding phase 15. These embodiments facilitate improvement of fracture resistance. The content of each of the β component and Co in the coating adhesion phase 9 may be 50-95% by mass. The content of the β component and Co in the binding phase 15 may be 20-60% by mass. The term “content of each of the β component and Co” means a sum of the content of the β component and the content of Co.

Examples of the β component may include Ti. Individual compositions of the hard phase 11, the solid solution phase 13, and the binding phase 15 may be measured by, for example, the EDS. Measurements may be made using an EDS included in an electronic microscope.

The coating adhesion phase 9 may have a wavy shape in a cross section vertical to the surface 5 of the base 3 as in the non-limiting embodiment illustrated in FIG. 2. This embodiment facilitates improvement of fracture resistance. A part of the coating adhesion phase 9 on a side opposite to the interface S may be in contact with the hard phase 11 in the above cross section. The part in contact with the hard phase 11 in the coating adhesion phase 9 may have a wavy shape.

The coating adhesion phase 9 may have an average thickness of 0.05-0.5 μm. This embodiment facilitates improvement of fracture resistance.

The thickness of the coating adhesion phase 9 may be measured by a cross-section observation using the electronic microscope. For example, the thickness may be measured at five or more measuring points at an arbitrary position of the coating adhesion phase 9, and an average value thereof may be calculated.

The coating adhesion phase 9 may be formed in 20-70% of the interface S between the base 3 and the coating layer 7 in the cross section vertical to the surface 5 of the base 3 as in the non-limiting embodiment illustrated in FIG. 2. This embodiment facilitates improvement of adhesion between the base 3 and the coating layer 7.

The coating adhesion phase 9 may be discontinuous in a direction along the interface S in the cross section vertical to the surface 5 of the base 3 as in the non-limiting embodiment illustrated in FIG. 2. This embodiment facilitates improvement of fracture resistance.

If the coating adhesion phase 9 is discontinuous, the hard phase 11 may be located between the coating adhesion phases 9 adjacent to each other. The coating adhesion phases 9 adjacent to each other may be in contact with the hard phase 11 located therebetween. The coating adhesion phase 9 is not limited to having the configuration in which the coating adhesion phase 9 is discontinuous in the direction along the interface S. The coating adhesion phase 9 may be continuous in the direction along the interface S.

A composition of the base 3 may include Nb (niobium). This embodiment facilitates enhancement of wear resistance of the coated tool 1. A content of Nb in the base 3 may be 0.1-3% by mass.

The base 3 may be cemented carbide including the hard phase 11, the solid solution phase 13, and the binding phase 15. The base 3 may further include a β phase 17. The Nb may be contained in the β phase 17 or the binding phase 15 or both of them. This embodiment facilitates enhancement of wear resistance of the coated tool 1.

The β phase 17 may be a composite carbide containing at least one of Ti, Nb, Ta (tantalum), and Zr (zirconium), and W. A composition of the β phase 17 may be measured by, for example, the EDS.

The coating layer 7 may be located on the whole or a part of the surface 5 of the base 3. That is, the coating layer 7 may be located on at least the part of the surface 5 of the base 3.

The coating layer 7 may be deposited by Chemical Vapor Deposition (CVD) method. In other words, the coating layer 7 may be a CVD film. Alternatively, the coating layer 7 may be a PVD film deposited by Physical Vapor Deposition (PVD) method.

The coating layer 7 may be configured with a single layer or a plurality of laminated layers. Examples of composition of the coating layer 7 may include TiCN (titanium carbonitride), Al₂O₃ (alumina), and TiN (titanium nitride).

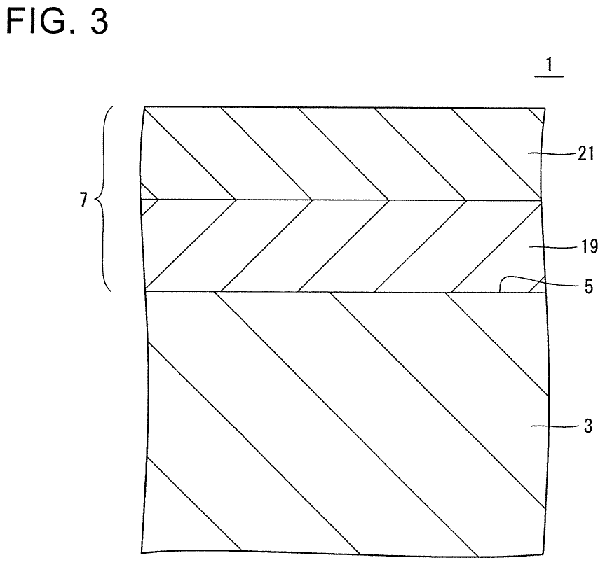

The coating layer 7 may include a TiCN layer 19 and an Al₂O₃ layer 21 in sequence from a side of the base 3 as in a non-limiting embodiment illustrated in FIG. 3. The TiCN layer 19 may be in contact with the base 3. The Al₂O₃ layer 21 may be in contact with the TiCN layer 19.

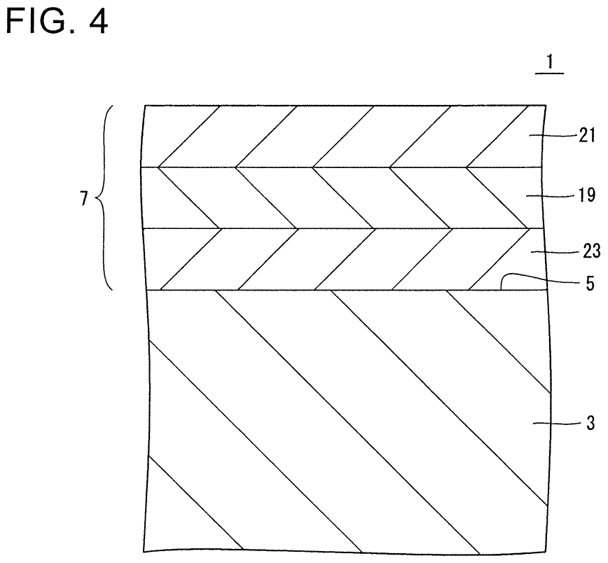

The coating layer 7 may include a TiN layer 23, a TiCN layer 19, and an Al₂O₃ layer 21 from a side of the base 3 as in a non-limiting embodiment illustrated in FIG. 4. The TiN layer 23 may be in contact with the base 3. The TiCN layer 19 may be in contact with the TiN layer 23. The Al₂O₃ layer 21 may be in contact with the TiCN layer 19.

The coating layer 7 is not limited to having a specific thickness. For example, an average thickness of the TiCN layer 19 may be set to approximately 1-15 μm. An average thickness of the Al₂O₃ layer 21 may be set to approximately 1-15 μm. An average thickness of the TiN layer 23 may be set to approximately 0.1-5 μm. Thickness measurement of the coating layer 7 may be made by the cross-section observation using the electron microscope. For example, the thickness measurement may be made at 10 or more measuring points at an arbitrary position of the individual layers, and an average value thereof may be calculated.

FIG. 1 illustrates a cutting insert as a non-limiting embodiment of the coated tool 1. The coated tool 1 is not limited to the cutting insert.

The coated tool 1 may include a first surface 25 (upper surface), a second surface 27 (lateral surface) adjacent to the first surface 25, and a cutting edge 29 located on at least a part of a ridgeline part of the first surface 25 and the second surface 27.

The first surface 25 may be a rake surface. The whole or a part of the first surface 25 may be the rake surface. For example, a region along the cutting edge 29 in the first surface 25 may be the rake surface.

The second surface 27 may be a flank surface. The whole or a part of the second surface 27 may be the flank surface. For example, a region along the cutting edge 29 in the second surface 27 may be the flank surface.

The cutting edge 29 may be located on a part or the whole of the ridgeline part. The cutting edge 29 is usable for machining a workpiece. The coating adhesion phase 9 may be located at the interface S between the base 3 and the coating layer 7 where the cutting edge 29 is located. With this embodiment, the cutting edge 29 is less prone to fracture.

The coated tool 1 may include a through hole 31. The through hole 31 is usable for attaching a fixing screw or clamping member when holding the coated tool 1 in a holder. The through hole 31 may be formed from the first surface 25 to a surface (lower surface) located on a side opposite to the first surface 25. The through hole 31 may also open into these surfaces. There is no problem even if the through hole 31 is configured to open into regions opposed to each other in the second surface 27.

The coated tool 1 may have a quadrangular plate shape. The shape of the coated tool 1 is not limited to the quadrangular plate shape. For example, the first surface 25 may have a triangular shape, a pentagonal shape, a hexagonal shape, or a circular shape.

The coated tool 1 is not limited to having specific dimensions. For example, a length of one side of the first surface 25 may be set to approximately 3-20 mm. A height from the first surface 25 to the surface (lower surface) on the side opposite to the first surface 25 may be set to approximately 5-20 mm.

### <Method for Manufacturing Coated Tool>

A method for manufacturing a coated tool in a non-limiting embodiment of the present disclosure is described below by exemplifying the case of manufacturing the coated tool 1.

A base 3 may be made initially when manufacturing the coated tool 1. A description is given by exemplifying the case where a base 3 composed of cemented carbide is manufactured as the base 3. Firstly, WC powder, TiC powder, TaC powder, ZrC powder, Co powder, and NbC powder may be prepared as raw material powder.

A proportion of the TiC powder may be 0.5-5% by mass. A proportion of the TaC powder may be 0.1-5% by mass. A proportion of the ZrC powder may be 0.2-5% by mass. A proportion of the Co powder may be 4-15% by mass. A proportion of the NbC powder may be 0.1-3% by mass. The rest may be the WC powder.

Mean particle diameters of the raw material powders may be suitably selected in a range of 0.1-10 μm. The mean particle diameters of the raw material powders may be values measured by micro track method.

A molded body may be obtained by mixing the prepared raw material powders, followed by molding. Examples of molding method may include press molding, casting molding, extrusion molding, and cold isostatic pressing.

The obtained molded body may be subjected to debinding treatment and then sintering. The sintering may be carried out in a non-oxidizing atmosphere, such as vacuum, argon atmosphere, and nitrogen atmosphere. A sintering temperature may be 1450-1600° C. Sintering time may be 0.5-3 hours.

The base 3 composed of cemented carbide may be obtained by sintering, followed by cooling. A cooling rate may be set to 6-20° C./min. More specifically, the cooling rate may be set to 6-15° C./min. In cases where the NbC powder is used as the raw material powder and the cooling is carried out at the above cooling rate, it is easy to incorporate Nb contained in the composition of the base 3 into the β phase 17 or the binding phase 15 or both of them.

Additionally, a keeping step may be added during cooling. The term “keeping step” as used herein is the step that may be added to a cooling step discussed in the preceding section. The cooling step may include the process of maintaining a temperature of a sintered body for a certain time instead of monotonously cooling the sintered body at a predetermined cooling rate. The process of maintaining the temperature of the sintered body is the “keeping step.” Maintaining the temperature of the sintered body need not strictly hold the temperature constant. However, if a value obtained by dividing a difference in temperature before and after the “keeping step” by time to carry out the keeping step is smaller than a predetermined cooling rate, it may be considered that the temperature of the sintered body is maintained. With this embodiment, the base 3 can easily include the coating adhesion phase 9. The keeping step may be carried out under the following conditions.
Time: 0.5-2 hours
Temperature: 800-1000° C.
Pressure: 5-10 kPa
Atmosphere: hydrogen atmosphere

For example, the keeping step is added when cooling the sintered body by setting the cooling rate to 10° C./min. Conditions of the keeping step at that time are as follows: A set temperature is 900° C.; a temperature at the time of starting is 930° C.; a temperature at the time of termination is 870° C.; and time is set to one hour (60 minutes). A rate of temperature change in the keeping step is 1 [=(930-870)/60] (° C./min), and is smaller than a cooling rate 10° C./min. Therefore, it can be said that the keeping step was added during the cooling.

Subsequently, a coating layer 7 may be deposited on a surface 5 of the obtained base 3 by CVD method, thereby obtaining the coated tool 1.

The TiCN layer 19 may be deposited as follows. Firstly, a mixed gas composed of 0.1-10% by volume of titanium tetrachloride (TiCl₄) gas, 10-60% by volume of nitrogen (N₂) gas, 0.1-15% by volume of methane (CH₄) gas, and the rest that is hydrogen (H₂) gas may be prepared as a reaction gas composition. Then, the mixed gas may be introduced into a chamber to deposit the TiCN layer 19 by setting a temperature of 800-1100° C. and a pressure of 5-30 kPa.

The Al₂O₃ layer 21 may be deposited as follows. Firstly, a mixed gas composed of 0.5-5% by volume of aluminum trichloride (AlCl₃) gas, 0.5-3.5% by volume of hydrogen chloride (HCL) gas, 0.5-5% by volume of carbon dioxide (CO₂) gas, 0.5% by volume or less of hydrogen sulfide (H₂S) gas, and the rest that is hydrogen (H₂) gas may be prepared as a reaction gas composition. Then, the mixed gas may be introduced into the chamber to deposit the Al₂O₃ layer 21 by setting a temperature of 930-1010° C. and a pressure of 5-10 kPa.

The TiN layer 23 may be deposited as follows. Firstly, a mixed gas composed of 0.1-10% by volume of titanium tetrachloride (TiCl₄) gas, 10-60% by volume of nitrogen (N₂) gas, and the rest that is hydrogen (H₂) gas may be prepared as a reaction gas composition. Then, the mixed gas may be introduced into the chamber to deposit the TiN layer 23 by setting a temperature of 800-1010° C. and a pressure of 10-85 kPa.

The above manufacturing method is one embodiment of the method for manufacturing the coated tool 1. Therefore, it is needless to say that the coated tool 1 is not limited to one which is manufactured by the above manufacturing method.

### <Cutting Tool>

A cutting tool 101 in a non-limiting embodiment of the present disclosure is described below with reference to the drawings by exemplifying the case of including the coated tool 1.

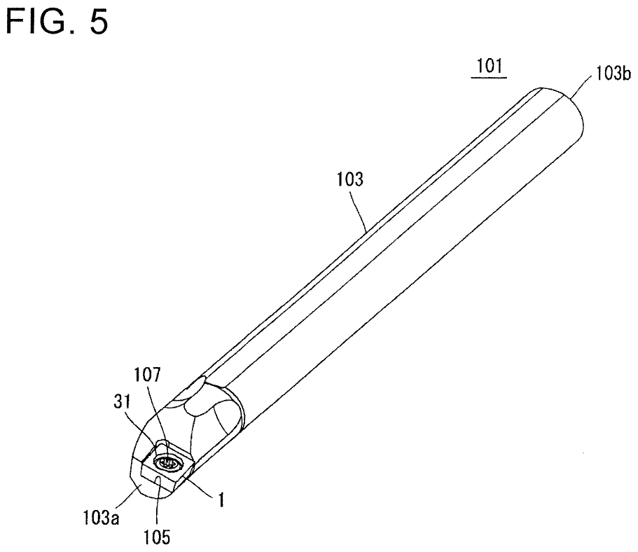

The cutting tool 101 may include a holder 103 that extends from a first end 103a toward a second end 103b and includes a pocket 105 on a side of the first end 103a, and the coated tool 1 located in the pocket 105 as in a non-limiting embodiment illustrated in FIG. 5. If the cutting tool 101 includes the coated tool 1, a stable machining can be carried out because of the high wear resistance of the coated tool 1.

The pocket 105 may be a part that permits attachment of the coated tool 1. The pocket 105 may open into an outer peripheral surface of the holder 103 and an end surface on a side of the first end 103a.

The coated tool 1 may be attached to the pocket 105 so that a cutting edge 29 can be protruded outward from the holder 103. The coated tool 1 may also be attached to the pocket 105 by a fixing screw 107. That is, the coated tool 1 may be attached to the pocket 105 by inserting the fixing screw 107 into a through hole 31 of the coated tool 1, and by inserting a front end of the fixing screw 107 into a screw hole formed in the pocket 105 so as to ensure engagement between screw parts. In this case, a lower surface of the coated tool 1 may be directly contacted with the pocket 105, or alternatively, a sheet may be held between the coated tool 1 and the pocket 105.

For example, steel and cast iron are usable as a material of the holder 103. If the material of the holder 103 is steel, the holder 103 has high toughness.

The cutting tool 101 used for a so-called turning process is exemplified in the embodiment illustrated in FIG. 5. Examples of the turning process may include internal machining, external machining, and grooving process. The use of the cutting tool 101 is not limited to the turning process. For example, there is no problem even if the cutting tool 101 is used for a milling process.

While the coated tool 1 and the cutting tool 101 in the non-limiting embodiments of the present disclosure have been exemplified above, the present disclosure is not limited to the above embodiments. Needless to say, it is possible to make any arbitrary one without departing from the scope of the present disclosure.

Although the above non-limiting embodiment has described, for example, the case of applying the coated tool 1 to the cutting tool 101, the coated tool 1 is also applicable to other uses. Examples of other uses may include wear-resistant parts such as sliding parts and metal molds, digging tools, tools such as edged tools, and impact-resistant parts.

The coated tool 1 and the cutting tool 101 may have the following configurations.

(1) The coated tool is one which includes a base and a coating layer located on a surface of the base. The base includes a coating adhesion phase containing at least one kind of metal compound selected from carbide, nitride, and carbonitride, each of which contains Ti and W, and Co. The coating adhesion phase is located at an interface between the base and the coating layer.

(2) The base may be cemented carbide including a hard phase containing w and C, a solid solution phase containing W, C, and Ti, and a binding phase containing an iron group metal, and the coating adhesion phase may have a larger content of each of a β component and Co than the binding phase in the coated tool of the above (1).

(3) The coating adhesion phase may have a wavy shape in a cross section vertical to the surface of the base in the coated tool of the above (1) or (2).

(4) The coating adhesion phase may have an average thickness of 0.05-0.5 μm in the coated tool of any one of the above (1) to (3).

(5) The coating adhesion phase may be formed in 20-70% of the interface between the base and the coating layer in a cross section vertical to the surface of the base in the coated tool of any one of the above (1) to (4).

(6) A composition of the base may include Nb in the coated tool of any one of the above (1) to (5).

(7) The base may be cemented carbide including a hard phase containing W and C, a solid solution phase containing W, C, and Ti, and a binding phase containing an iron group metal, the base may further include a β phase, and the Nb may be contained in the β phase or the binding phase or both of them in the coated tool of the above (6).

(8) The coating layer may include a TiCN layer and an Al₂O₃ layer in sequence from a side of the base in the coated tool of any one of the above (1) to (7).

(9) The coating layer may include a TiN layer, a TiCN layer, and an Al₂O₃ layer in sequence from a side of the base in the coated tool of any one of the above (1) to (7).

(10) A cutting tool can include a holder that extends from a first end toward a second end and includes a pocket on a side of the first end, and the coated tool of any one of the above (1) to (9) located in the pocket.

Although the present disclosure is described in detail below by giving Examples, the present disclosure is not limited to the following Examples.

### Examples

### Samples Nos. 1 and 2

### <Manufacturing of Coated Tools>

Firstly, WC powder whose mean particle diameter was 3 μm, TiC powder whose mean particle diameter was 1 μm, TaC powder whose mean particle diameter was 1 μm, ZrC powder whose mean particle diameter was 1 μm, Co powder whose mean particle diameter was 1.5 μm, and NbC powder whose mean particle diameter was 1 μm were prepared as raw material powder. These mean particle diameters of the raw material powders were values measured by micro-track method.

Subsequently, a molded body was obtained by mixing these raw material powders so that a composition of a coating adhesion phase in a sintered body could be a composition A or a composition B in Table 1, followed by press molding into a cutting tool shape (CNMG120408). The obtained molded body was subjected to debinding treatment and then sintering while being held at a temperature of 1450-1600° C. for 0.5-2 hours. Then, a base composed of cemented carbide was obtained by cooling after the sintering. At that time, a cooling rate was set to conditions presented in Table 2.

A keeping step was added during the cooling. The keeping step was carried out under the following conditions.
Time: 1 hour
Temperature: 850° C.
Pressure: 7.5 kPa
Atmosphere: hydrogen atmosphere

A coating layer was deposited on a surface of the obtained base by CVD method, thereby obtaining a coated tool presented in Table 2. As to the coating layer, a TiN layer whose average thickness was 1 μm, a TiCN layer whose average thickness was 10 μm, and an Al₂O₃ layer whose average thickness was 5 μm were deposited in sequence from a side of the base.

A composition of the base was measured by an EDS. Specifically, a cross-section observation was carried out using the EDS included in an SEM. Arbitrary three locations were measured at 5000-20000× magnification, and an average value thereof was calculated.

Measurement results by the EDS showed that each of obtained bases included a hard phase containing W and C as a main component, a solid solution phase containing W, C, and Ti as a main component, and a binding phase containing an iron group metal (Co) as a main component. Each of the bases also included a coating adhesion phase of the composition A or B in Table 1. The coating adhesion phase was located at an interface between the base and the coating layer. The coating adhesion phase had a larger content of each of a β component (Ti) and Co than the binding phase.

The coating adhesion phase had a wavy shape in a cross section vertical to the surface of the base. More specifically, a part of the coating adhesion phase which was located on a side opposite to the interface was in contact with the hard phase in the above cross section. The part in contact with the hard phase in the coating adhesion phase had the wavy shape.

The coating adhesion phase had an average thickness of 0.2 μm. The coating adhesion phase was formed in 60% of the interface in the above cross section.

As to the base obtained with the composition A, the composition of the base included Nb, and the base included the β phase. Measurement results of composition of the β phase by the EDS showed that the β phase was (W, Ti, Nb, Ta, Zr) C, and the Nb was contained in the β phase and the binding phase.

### Sample No. 3

A base was manufactured under the same conditions as in Sample No. 1, except that a cooling rate was set to conditions presented in Table 2, and no keeping step was added during cooling. The same coating layer as in Sample No. 1 was deposited on a surface of the base by the CVD method, thereby obtaining a coated tool presented in Table 2.

A composition of the base was measured by the EDS under the same conditions as in Samples Nos. 1 and 2. The result showed that the obtained base included a hard phase containing W and C as a main component, a solid solution phase containing w, C, and Ti as a main component, and a binding phase containing an iron group metal (Co) as a main component, but included no coating adhesion phase.

### Evaluations

The obtained coated tools were subjected to a machining evaluation under the following conditions:
Machining Type: Turning
Cutting Speed: 150 m/min
Feed: 0.4 mm/rev
Depth of Cut: 0.5 mm
Workpiece: SCM435 ϕ200 round rod (with four grooves)
Machining State: WET
Others: Measurements were made by n=4, and an average value thereof was calculated.

Evaluation results are shown in Table 2. The term “number of impacts until occurrence of fracture of cutting edge” in the evaluation result of Table 2 indicates the number of impacts until the cutting edge fractures during a machining process. This may also be called an intermittent performance evaluation.

TABLE 1

| Composition of | A | B |
|---|---|---|
| coating adhesion phase | (% by mass) | (% by mass) |
| WC | 85.8 | 87 |
| TiC | 2.5 | 2 |
| TaC | 3 | 3 |
| ZrC | 1 | 1 |
| Co | 7 | 7 |
| NbC | 0.7 | 0 |
| Total | 100 | 100 |

TABLE 2

| | Sintering | Presence or | | Evaluation result |
|---|---|---|---|---|
| | condition | absence of | | Number of impacts |
| | Cooling | coating | Ccomposition | until occurrence of |
| Sample | rate | adhesion | of coating | fracture of cutting |
| No. | (° C./min) | phase | adhesion phase | edge (times) |
| 1 | 14 | Present | A | 7800 |
| 2 | 10 | Present | B | 3100 |
| 3 | 3 | Absent | — | 2000 |

Compared to Sample No. 3, Samples Nos. 1 and 2 had enhanced wear resistance of the cutting edge, and it was possible to perform a stable machining as a cutting tool.

### DESCRIPTION OF THE REFERENCE NUMERAL

1 coated tool
3 base
5 surface
7 coating layer (film layer)
9 coating adhesion phase
11 hard phase
13 solid solution phase
15 binding phase
17 β phase
19 TiCN layer
21 Al₂O₃ layer
23 TiN layer
25 first surface (upper surface)
27 second surface (lateral surface)
29 cutting edge
31 through hole
101 cutting tool
103 holder
103a first end
103b second end
105 pocket
107 fixing screw
S interface

1. A coated tool, comprising:
a base; and
a coating layer located on a surface of the base, wherein
the base comprises a coating adhesion phase comprising at least one kind of metal compound selected from carbide, nitride, and carbonitride, each of which comprises Ti and W, and Co,
the coating adhesion phase is located at an interface between the base and the coating layer.

2. The coated tool according to claim 1, wherein
the base is cemented carbide comprising
a hard phase comprising W and C,
a solid solution phase comprising W, C, and Ti, and
a binding phase comprising an iron group metal, and
the coating adhesion phase has a larger content of each of a β component and Co than the binding phase.

3. The coated tool according to claim 1, wherein the coating adhesion phase has a wavy shape in a cross section vertical to the surface of the base.

4. The coated tool according to claim 1, wherein the coating adhesion phase has an average thickness of 0.05-0.5 μm.

5. The coated tool according to claim 1, wherein the coating adhesion phase is formed in 20-70% of the interface between the base and the coating layer in the cross section vertical to the surface of the base.

6. The coated tool according to claim 1, wherein a composition of the base comprises Nb.

7. The coated tool according to claim 6, wherein
the base is cemented carbide comprising
a hard phase comprising W and C,
a solid solution phase comprising W, C, and Ti, and
a binding phase comprising an iron group metal,
the base further comprises a β phase, and
the Nb is contained in the β phase or the binding phase or both of them.

8. The coated tool according to claim 1, wherein the coating layer comprises a TiCN layer and an Al₂O₃ layer in sequence from a side of the base.

9. The coated tool according to claim 1, wherein the coating layer comprises a TiN layer, a TiCN layer, and an Al₂O₃ layer in sequence from a side of the base.

10. A cutting tool, comprising:
a holder extending from a first end toward a second end and comprising a pocket on a side of the first end; and
the coated tool according to claim 1, the coated tool being located in the pocket.
